(19) United States
(12) Patent Application Publication
(10) Pub. No.: US 2025/0266960 A1
(43) Pub. Date: Aug. 21, 2025

(54) SYSTEMS AND METHODS FOR DEMODULATION REFERENCE SIGNAL (DMRS) BUNDLING IN NON TERRESTRIAL NETWORK (NTN)

(71) Applicant: ZTE CORPORATION, Shenzhen (CN)

(72) Inventors: Yachao YIN, Shenzhen (CN); Fangyu CUI, Shenzhen (CN); Nan ZHANG, Shenzhen (CN); Junli LI, Shenzhen (CN)

(73) Assignee: ZTE CORPORATION, Shenzhen (CN)

(21) Appl. No.: 19/197,271

(22) Filed: May 2, 2025

Related U.S. Application Data
(63) Continuation of application No. PCT/CN2023/086451, filed on Apr. 6, 2023.

(51) Int. Cl. H04L 5/00

(52) U.S. Cl. CPC H04L 5/0051

(57) ABSTRACT

Presented are systems and methods for demodulation reference signal (DMRS) bundling in non-terrestrial network (NTN). A wireless communication device may send an indication of capability of the wireless communication device to a wireless communication node. The capability can be associated with pre-compensation of segments of an uplink transmission. The wireless communication device may transmit the uplink transmission with a time domain window (TDW) for bundling of demodulation reference signals (DMRSes) according to the capability.

### CROSS-REFERENCE TO RELATED APPLICATION

This application claims the benefit of priority under 35 U.S.C. § 120 as a continuation of PCT Patent Application No. PCT/CN2023/086451, filed on Apr. 6, 2023, the disclosure of which is incorporated herein by reference in its entirety.

### TECHNICAL FIELD

The disclosure relates generally to wireless communications, including but not limited to systems and methods for demodulation reference signal (DMRS) bundling in non-terrestrial network (NTN).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A wireless communication device (e.g., a UE) may send an indication of capability of the wireless communication device to a wireless communication node (e.g., a BS). The capability can be associated with pre-compensation of segments of an uplink transmission. The wireless communication device may transmit the uplink transmission (e.g., repetitions of physical uplink shared channel (PUSCH) transmissions) with a time domain window (TDW) for bundling of demodulation reference signals (DMRSes) according to the capability. In some embodiments, the actual TDW can be determined by the UE when events (which violate power consistency and phase continuity) occur. The UE may determine the actual TDWs. Events, which cause power consistency and phase continuity not to be maintained across PUSCH transmissions of PUSCH repetition type A scheduled by DCI format 0_1 or 0_2, or PUSCH repetition Type A with a configured grant, or PUSCH repetition type B or TB processing over multiple slots, or PUCCH transmissions of PUCCH repetition, within the nominal TDW, can be uplink timing adjustment or frequency hopping.

In some embodiments, the capability may comprise at least one of: (1) capability of the wireless communication device to perform the pre-compensation of the segments of the uplink transmission; (2) capability of the wireless communication device to support or provide a segment length for the pre-compensation of the segments; (3) capability of the wireless communication device to support a TDW size that is longer than the segment length for the pre-compensation of the segments; or (4) capability of the wireless communication device to support a maximum TDW size that is longer than the segment length for the pre-compensation of the segments.

In some embodiments, the wireless communication device may determine the TDW for bundling of DMRSes, according to at least one of: a new event of the pre-compensation of segments that violates power consistency and phase continuity between the segments; assistance information of the wireless communication device that is indicative of updated information or timing information of the pre-compensation; or a configuration of the wireless communication node that is indicative of the updated information or timing information of the pre-compensation. The TDW can be determined by assistance information and can define a new event of segmented pre-compensation. The assistance information can include reported assistance information by the UE or configuration indicated by the network

In some embodiments, the wireless communication device may receive, from the wireless communication node, an indication of whether the wireless communication node is to perform phase post-compensation. The wireless communication device may receive, from the wireless communication node, a configuration information comprising at least one of a nominal TDW, a segment length for the pre-compensation of the segments, or a maximum TDW size across multiple segments. The wireless communication device may send, to the wireless communication node, assistance information comprising at least one of an indication of the segment length or timing information of the pre-compensation of the segments. The timing information may include at least one of: a start time or an end time, of the pre-compensation or the TDW. The UE can send a signal to the BS when the UE starts/ends the pre-compensation. The UE can calculate/estimate/send the start/end time of the pre-compensation. The timing information can be a time instance, or a system frame number (SFN). When the capability comprises (1) or (2), the method may comprise: determining the actual TDW that is to end before the new event occurs, according to at least one of: the segment length, the start time, or the end time (e.g., last symbol of a PUSCH transmission before the event).

When the capability comprises (3) or (4), the method comprises: determining the actual TDW according to at least one of: a scaling factor, or an offset with respect to a the segment length configured by the wireless communication node, or a nominal TDW indicated by the wireless communication node; or a maximum TDW indicated by the wireless communication device. A new TDW can be configured by the network, e.g., segment length or longer than segment length. The nominal TDW can be determined by the UE from BS the indication (e.g., PUSCH−TimeDomainWindowLength) if configured. The nominal TDW can be computed as min ([maxDMRS−BundlingDuration], M), if PUSCH-TimeDomainWindowLength is not configured. [maxDMRS−BundlingDuration] can be a maximum duration for a nominal TDW subject to UE capability. M can be the time duration in consecutive slots for all PUSCH repetitions transmissions. A maximum TDW can be subject to UE capability of across segments.

In some embodiments, the method may comprise: determining the TDW to have at least one of: a start time occurring at a first symbol of a first physical uplink shared channel (PUSCH) transmission in a slot, from PUSCH transmissions of the uplink transmission over multiple slots within a nominal TDW, or an end time occurring at a last symbol of a last PUSCH transmission in the another slot, from the PUSCH transmissions within the nominal TDW. The start and end times may not be in the same slot, but can be in same nominal TDW. The PUSCH transmission may include multiple repetitions.

When the capability comprises (1) or (2), and the wireless communication node is to perform post-compensation of phase drift, the method may comprise: determining the TDW according to at least one of: a scaling factor, or an offset with respect to a segment length configured by the wireless communication node, a nominal TDW indicated by the wireless communication node; or a maximum TDW indicated by the wireless communication device.

When the capability comprises (1) or (2), and the wireless communication node is to perform post-compensation of phase drift, the method may comprise: determining the TDW to have at least one of: a start time occurring at a first symbol of a first physical uplink shared channel (PUSCH) transmission in a slot, from PUSCH transmissions of the uplink transmission over multiple slots within a nominal TDW, or an end time occurring at a last symbol of a last PUSCH transmission in the slot, from the PUSCH transmissions within the nominal TDW. When the capability comprises (1) or (2), and the wireless communication node is not to perform post-compensation of phase drift, the method may comprise: determining the TDW before the new event of segmented pre-compensation according to at least one of: the segment length, the start time, or the end time.

In some embodiments, the wireless communication device may send, to the wireless communication node, via at least one signaling, at least one of: the indication of the capability, or the assistance information. The at least one signaling may comprise at least one of: a radio access control (RRC) signaling; or a medium access control control element (MAC CE) signaling. The wireless communication device may receive the indication of whether the wireless communication node is to perform post-compensation of phase drift and new event of segmented pre-compensation, to the wireless communication node via at least one of: a radio access control (RRC) signaling; a master information block (MIB) signaling; or a system information block (SIB) signaling.

In some embodiments, when (i) the wireless communication node configures a nominal TDW that is longer than a segment length for the pre-compensation of the segments, and (ii) the capability comprises (1) or (2), the method may comprise: determining the TDW according to at least one of: the segment length, the start time, or the end time. When the wireless communication node configures a nominal TDW that is equal to a segment length for the pre-compensation of the segments, the method may comprise: determining the TDW according to the nominal TDW configured by the wireless communication device. When the wireless communication node configures a nominal TDW that is equal to maximum TDW size that is longer than a segment length for the pre-compensation of the segments, the method may comprise: determining the TDW according to the maximum TDW.

In some embodiments, when the capability comprises that the wireless communication device cannot perform the pre-compensation, the TDW can be determined via a defined or pre-existing approach.

In some embodiments, a wireless communication node (e.g., a BS) may receive an indication of capability of the wireless communication device from a wireless communication device (e.g., a UE). The capability can be associated with pre-compensation of segments of an uplink transmission (e.g., repetitions of PUSCH transmissions). The wireless communication node may receive, from the wireless communication device, the uplink transmission with a time domain window (TDW) for bundling of demodulation reference signals (DMRSes), according to the capability.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example non-terrestrial network (NTN), in accordance with some embodiments of the present disclosure;

FIG. 4 illustrates segmented pre-compensation, in accordance with some embodiments of the present disclosure;

FIG. 5 illustrates a flow diagram for demodulation reference signal (DMRS) bundling in non-terrestrial network (NTN), in accordance with an embodiment of the present disclosure;

FIG. 6 illustrates a flow diagram for demodulation reference signal (DMRS) bundling in non-terrestrial network (NTN), in accordance with an embodiment of the present disclosure;

FIG. 7 illustrates a flow diagram for demodulation reference signal (DMRS) bundling in non-terrestrial network (NTN), in accordance with an embodiment of the present disclosure; and

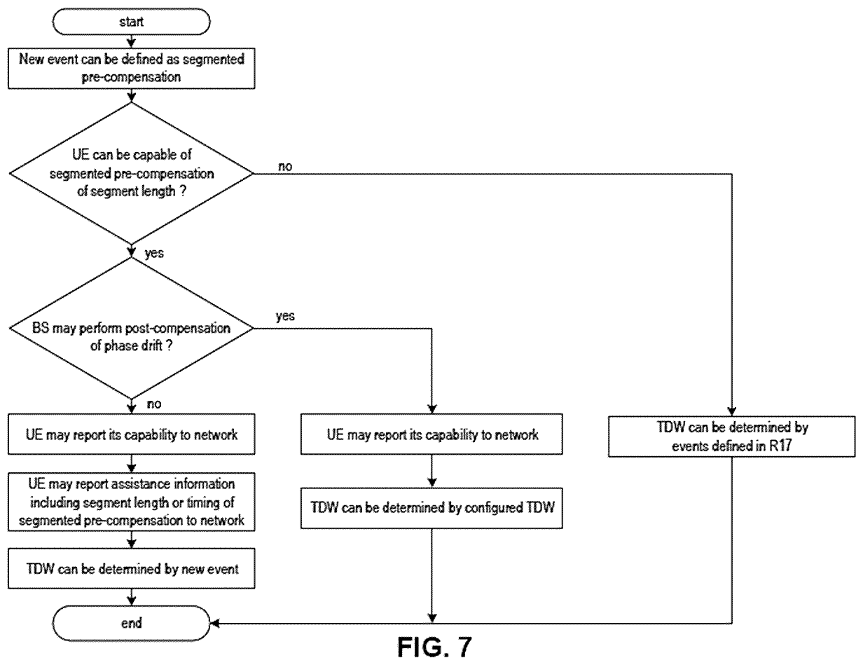

FIG. 8 illustrates a flow diagram for demodulation reference signal (DMRS) bundling in non-terrestrial network (NTN), in accordance with an embodiment of the present disclosure.

### DETAILED DESCRIPTION

### 1. Mobile Communication Technology and Environment

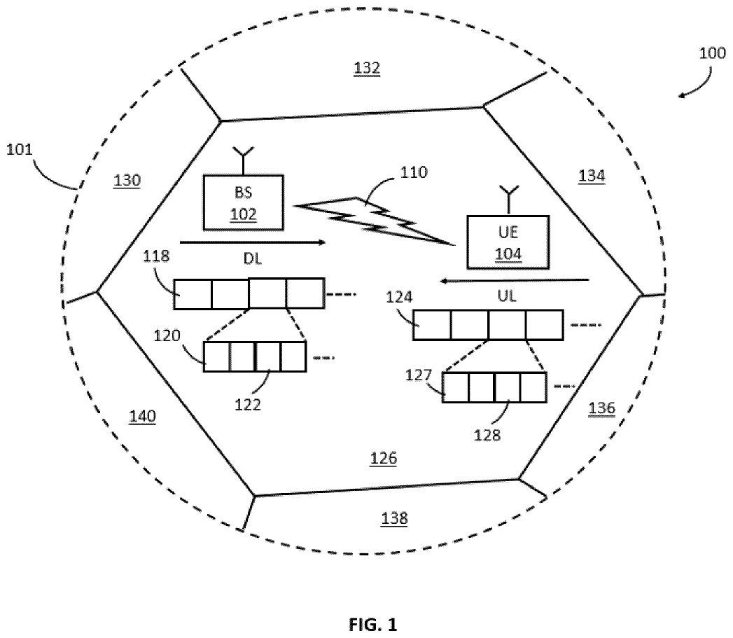

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

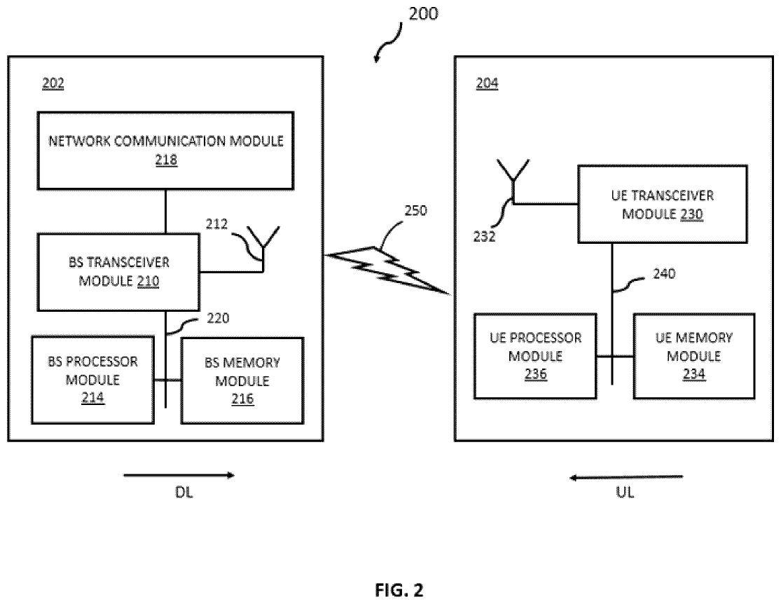

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Demodulation Reference Signal (DMRS) Bundling in Non-Terrestrial Network (NTN)

A coverage enhancement for non-terrestrial network (NTN) may mitigate performance loss due to a large distance between a user equipment (UE) and a satellite. An coverage enhancement for terrestrial network (TN) may comprise a demodulation reference signal (DMRS) bundling and/or a joint channel estimation (JCE). However, due to a high mobility of a satellite in NTN, timing drift may be fast and a timing advance (TA) pre-compensation value may be adjusted frequently. In order to enable DMRS bundling in NTN, a segmented pre-compensation at UE side can be used to maintain power consistency and phase continuity within the segmented length of UL transmission. However, even if the UE has the capability of segmented pre-compensation, the determination of DMRS bundling size (e.g., actual TDW) may not be known at BS side if there is no related signaling or assistance information. In this disclosure, how to achieve common consensus on the determination of actual TDW can be performed. On the other hand, when an advanced UE capable of enlarging TDW crosses UL segments by UE implementation is considered, how to determine the TDW size can be also performed.

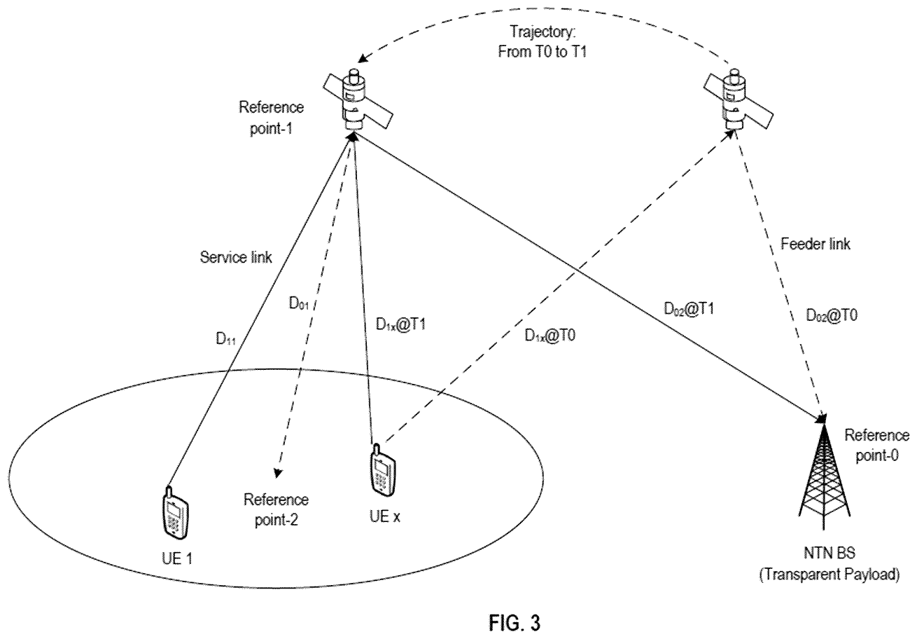

FIG. 3 illustrates an example representation of a NTN, e.g., a transparent NTN. In some embodiments, the link between a UE and a satellite may be a service link. The link between a base station (BS) and a satellite may be a feeder link. The feeder link can be common for all UEs within the same cell.

In TN systems, methods for coverage enhancement may include: repetition and/or joint channel estimation (JCE). For the repetition method, a transmitter can repetitively transmit a message for a period of time. A receiver can combine the repetition of the transmissions and may increase the performance of decoding. For the joint channel estimation (JCE) method, reference signals (RSs) at different time instances can be used jointly to estimate a channel. The JCE may provide a better estimation of channel and/or better decoding performance. In the JCE method, the DMRS can be bundled, such as considered quasi colocation (QCL) in the channel estimation.

Segmented pre-compensation may apply different pre-compensation of timing advances (TAs) and/or frequency offsets for different components of a single uplink (UL) transmission. In order to avoid the timing offset/frequency offset (TO/FO) exceeding a tolerable range, the pre-compensated TA and/or Doppler may be adjusted after a period of time to mitigate the timing and/or frequency drift caused by a satellite mobility. When the adjustment period is shorter than a total time of a single transmission (with multiple repetitions), the transmission may be divided into multiple segments. Each segment may apply or be subject to a TA and/or a Doppler pre-compensation value.

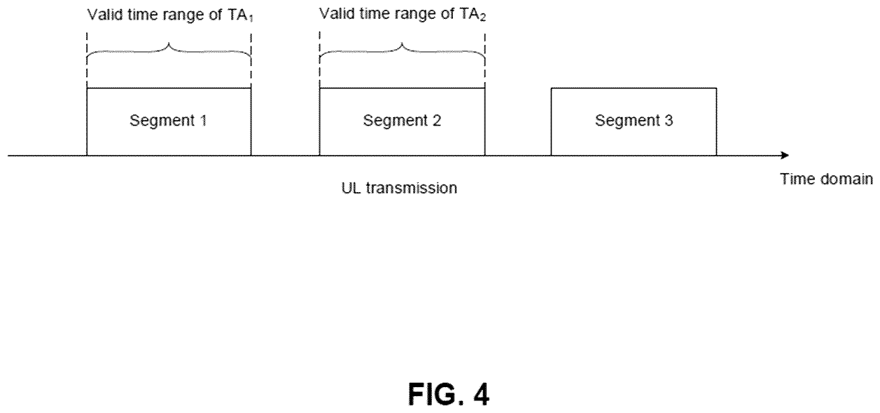

FIG. 4 illustrates segmented pre-compensation, in accordance with some embodiments of the present disclosure. The segmented pre-compensation can be beneficial to maintain power consistency and phase continuity during UL segments, but the DMRS bundling size (e.g., actual TDW size) can be determined by events. Specifically, the events may cause power consistency and phase continuity not to be maintained across PUSCH transmissions of PUSCH repetition type A scheduled by DCI format 0_1 or 0_2, or PUSCH repetition Type A with a configured grant, or PUSCH repetition type B or TB processing over multiple slots, or PUCCH transmissions of PUCCH repetition, within the nominal TDW. The events can be at least one of: a downlink slot or downlink reception or downlink monitoring based on tdd-UL-DL-ConfigurationCommon and tdd-UL-DL-ConfigurationDedicated for unpaired spectrum; the gap between any two consecutive PUSCH transmissions, or the gap between any two consecutive PUCCH transmissions, exceeds 13 symbols for normal cyclic prefix or exceeds 11 symbols for extended cyclic prefix; the gap between any two consecutive PUSCH transmissions, or the gap between any two consecutive PUCCH transmissions, does not exceed 13 symbols but other uplink transmissions are scheduled between the two consecutive PUSCH transmissions or the two consecutive PUCCH transmissions; for PUSCH transmissions of PUSCH repetition type A, or PUSCH repetition type B or TB processing over multiple slots, the events can be a dropping or cancellation of a PUSCH transmission; for PUCCH transmissions of PUCCH repetition, the events can be a dropping or cancellation of a PUCCH transmission; for any two consecutive PUSCH transmissions of PUSCH repetition type A, or PUSCH repetition type B, and when two SRS resource sets are configured in srs-ResourceSetToAddModList or srs-ResourceSetToAddModListDCI-0-2 with higher layer parameter usage in SRS-ResourceSet set to ‘codebook’ or ‘noncodebook’, a different SRS resource set association can be used for the two PUSCH transmissions of PUSCH repetition type A, or PUSCH repetition type B; for any two consecutive PUCCH transmissions of PUCCH repetition, and when a PUCCH resource used for repetitions of a PUCCH transmission by a UE includes first and second spatial relations or first and second sets of power control parameters, different spatial relations or different power control parameters can be used for the two PUCCH transmissions of PUCCH repetition; uplink timing adjustment in response to a timing advance command; a frequency hopping; or for reduced capability half-duplex UEs, the events can be a dropping or cancellation of a PUSCH or PUCCH transmission or an overlapping of the gap between two consecutive PUSCH or two consecutive PUCCH transmissions and any symbol of downlink reception or downlink monitoring.

For example, when the UE receives a nominal TDW configured by the network, the determination of the actual TDWs can be performed as follows: the start of the first actual TDW is the first symbol of the first PUSCH transmission in a slot for PUSCH repetitions transmissions within the nominal TDW; the end of an actual TDW is the last symbol of a PUSCH transmission before the event (e.g., uplink timing adjustment or frequency hopping). Hence, the determination of actual TDW may depend on different events. Similarly, power consistency and phase continuity may not be maintained between UL segments when the UE performs segmented pre-compensation during one UL segment. Therefore, the determination of actual TDW may be affected by segmented pre-compensation.

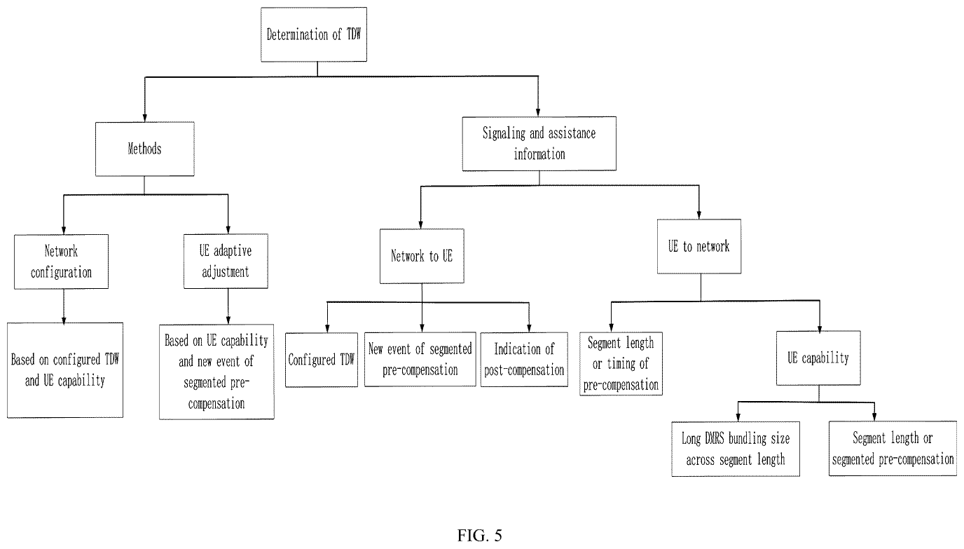

FIG. 5 illustrates a flow diagram for demodulation reference signal (DMRS) bundling in non-terrestrial network (NTN), in accordance with an embodiment of the present disclosure. For the determination of actual or nominal TDW, the following UE capabilities may be indicated to the BS: whether UE supports segmented pre-compensation; whether the UE can calculate/determine/provide the segment length for/of pre-compensation; whether UE supports DMRS TDW size longer than the segment length of pre-compensation, which means UE can achieve power consistency and phase continuity across UL segments based on segmented pre-compensation and UE implementation; or the maximum DMRS TDW size supported. When the UE supports DMRS TDW longer than segment length, which may indicate/mean that the UE can achieve power consistency and phase continuity crosses UL segments based on segmented pre-compensation and UE implementation. To achieve joint channel estimation with DMRS bundling in NTN, a new event of segmented pre-compensation can be defined to determine the actual TDW. In the meanwhile, the determination of actual TDW can be subject to UE capability.

### Implementation Example 1: The TDWs can be Determined Based on UE Capability of Segment Length or Segmented Pre-Compensation and New Event of Segmented Pre-Compensation

FIG. 5 illustrates a flow diagram for demodulation reference signal (DMRS) bundling in non-terrestrial network (NTN), in accordance with an embodiment of the present disclosure.

When a UE has capability of segmented pre-compensation to address/tackle with phase variation caused by timing or Doppler drift in NTN, an event of segmented pre-compensation can be defined and may occur. The event may violate power consistency and phase continuity between UL segments. The determination of TDW size can be impacted largely. To help BS and UE achieve the consensus on the TDW, at least one of following UE capabilities may be indicated to the BS: whether the UE supports segmented pre-compensation; the segment length of pre-compensation; or whether the UE supports DMRS TDW size longer than segment length of pre-compensation (which means the UE can achieve power consistency and phase continuity crosses UL segments based on segmented pre-compensation and UE implementation); or the maximum DMRS TDW size when UE supports DMRS TDW longer than segment length (which means UE can achieve power consistency and phase continuity crosses UL segments based on segmented pre-compensation and UE implementation).

As long as UE capability of segmented pre-compensation is supported, a DMRS bundling can be achieved but an event of segmented pre-compensation may occur (e.g., an event violates power consistency and phase continuity between UL segments). Therefore, an actual TDW can be determined with consideration of UE capability and the event.

(1) When the UE has no capability of segmented pre-compensation, an event of segmented pre-compensation may not occur and an actual TDW can be determined by events.

(2) When the UE has capability of segmented pre-compensation, an event of segmented pre-compensation may occur and an actual TDW can be determined by the event. In addition to reporting UE capabilities, assistance information including segment length or timing of segmented pre-compensation can be indicated to the BS. The UE may report the segment length calculated by itself or timing of segmented pre-compensation to the BS. The timing can be a sub frame number (SFN) to indicate the end of the actual TDW. The UE capability signaling and assistance information can be both reported through a RRC or MAC CE signaling.

(3) When the UE has capability of supported segment length of segmented pre-compensation, an event of segmented pre-compensation may occur and an actual TDW can be determined by the event. Based on the reported UE capabilities of supported segment length, the end of the actual TDW can be determined by the segment length when the event occurs. The UE capability signaling can be reported through a RRC or MAC CE signaling.

(4) When the UE has capability of DMRS TDW size longer than segment length of pre-compensation, an event of segmented pre-compensation may not occur and the actual TDW can be determined by the configured TDW or nominal TDW. Based on the reported UE capabilities, the start of the first actual TDW can be the first symbol of the first PUSCH transmission in a slot for PUSCH transmissions over multiple slots within the nominal TDW, the end of the actual TDW can be the last symbol of the last PUSCH transmission in a slot for PUSCH transmissions over multiple slots within the nominal TDW. The UE capability signaling can be reported through a RRC or MAC CE signaling.

(5) When the UE has capability of supported maximum DMRS TDW size longer than segment length, an event of segmented pre-compensation may not occur and the actual TDW can be determined by the configured TDW or the maximum DMRS TDW size. Based on the reported UE capabilities, the start of the first actual TDW can be the first symbol of the first PUSCH transmission in a slot for PUSCH transmissions over multiple slots within the nominal TDW, the end of the actual TDW can be the last symbol of the last PUSCH transmission in a slot for PUSCH transmissions over multiple slots within the nominal TDW. The UE capability signaling can be reported through a RRC or MAC CE signaling.

For example, for joint channel estimation of PUSCH repetitions over multiple slots, the PUSCH transmissions can be covered by one or more nominal TDWs. Once UE is capable of segmented pre-compensation, within one configured TDW, one or multiple actual TDWs can be determined. The start of the first actual TDW can be the first symbol of the first PUSCH transmission in a slot for PUSCH transmissions over multiple slots within the nominal TDW. The end of the first actual TDW can be: the last symbol of the last PUSCH transmission in a slot for PUSCH transmissions over multiple slots within the nominal TDW; or the last symbol of a PUSCH transmission, before the event occurs, where occurrence of such an event causes power consistency and phase continuity not to be maintained across PUSCH transmissions of PUSCH repetitions.

An event above can be defined as a segmented pre-compensation that violates power consistency and phase continuity between UL segments. The UE capability and assistance information may be reported for common consensus on the determination of actual TDW at UE and BS sides.

### Implementation Example 2: The TDWs can be Determined Based on UE Capability of Segmented Pre-Compensation and Post-Compensation at BS Side

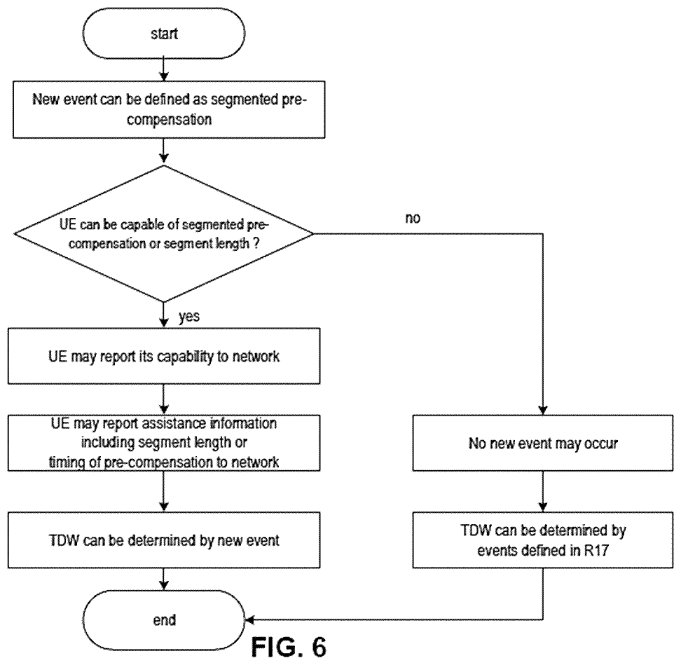

FIG. 6 illustrates a flow diagram for demodulation reference signal (DMRS) bundling in non-terrestrial network (NTN), in accordance with an embodiment of the present disclosure. If a post-compensation of phase drift is supported at BS side to reduce a phase difference effectively, an actual TDW size may be increased. The ability to support post-compensation of phase drift at BS side can be indicated through a SIB or RRC signaling. The determination of TDW can be further affected by post-compensation at BS and summarized as follows.

(1) When the UE has no capability of segmented pre-compensation, an event of segmented pre-compensation may not occur and the actual TDW can be determined by events.

(2) When the UE has capability of segmented length or segmented pre-compensation and BS performs post-compensation of phase drift, an event of segmented pre-compensation may not occur and the actual TDW can be determined by the configured TDW or the nominal TDW. The UE may report UE capability via a RRC or MAC CE signaling, and post post-compensation of phase drift at BS side and new event of segmented pre-compensation can be indicated to UE via a master information block (MIB), system information block (SIB), or radio access control (RRC) signaling.

(3) When the UE has capability of segmented pre-compensation and BS does not perform post-compensation of phase drift, an event of segmented pre-compensation may occur and the actual TDW can be determined by this event. The UE may report UE capability or assistance information mentioned above via a RRC or MAC CE signaling. An indication of non-performance/inability of post-compensation of phase drift at BS side and new event of segmented pre-compensation can be indicated to the UE via a MIB, SIB, or RRC signaling.

For example, when the UE has capability of segmented length or segmented pre-compensation and the BS performs post-compensation of phase drift, within one configured TDW, an actual TDW can be determined as follows: the start of the first actual TDW is the first symbol of the first PUSCH transmission in a slot for PUSCH transmissions over multiple slots within the nominal TDW; or the end of the first actual TDW is the last symbol of the last PUSCH transmission in a slot for PUSCH transmissions over multiple slots within the nominal TDW.

In such case, the event above can be defined as a segmented pre-compensation that violates/disrupts power consistency, and phase continuity between UL segments. The UE capability and assistance information may be reported for common consensus on the determination of actual TDW at UE and BS sides.

### Implementation Example 3: The TDWs can be Determined Based on Network Configuration

In addition to UE adaptive adjustment, an actual or nominal TDW can be determined by a network configuration. Possible cases can be summarized as follows.

Case-1: When network configures a nominal TDW longer than the segment length of UE capability, the actual TDW can be determined by an event of segmented pre-compensation.

Case-2: When network configures a nominal TDW equal to the segment length of UE capability, the actual TDW can be determined by configured TDW and an event of segmented pre-compensation may not occur.

Case-3: When network configures a nominal TDW equal to the maximum DMRS TDW size longer than segment length based on UE capability, the actual TDW can be determined by the maximum DMRS TDW size and an event of segmented pre-compensation may not occur.

In all cases, whether the event of segmented pre-compensation violates power consistency and phase continuity between UL segments may occur can be subject to UE capability. The UE capability may be reported via a RRC or MAC CE signaling for common consensus on the determination of actual TDW at UE and BS sides.

It should be understood that one or more features from the above implementation examples are not exclusive to the specific implementation examples, but can be combined in any manner (e.g., in any priority and/or order, concurrently or otherwise).

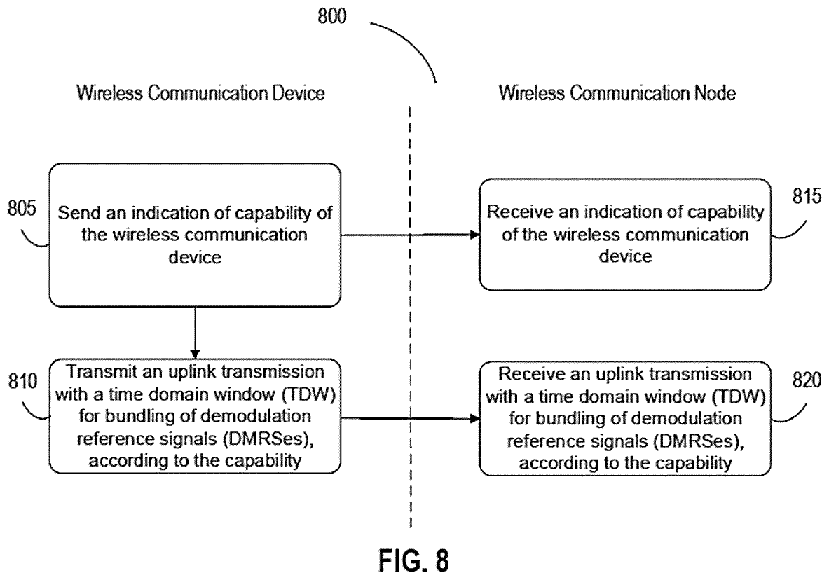

FIG. 8 illustrates a flow diagram for demodulation reference signal (DMRS) bundling in non-terrestrial network (NTN), in accordance with an embodiment of the present disclosure. The method 800 may be implemented using any one or more of the components and devices detailed herein in conjunction with FIGS. 1-2. In overview, the method 800 may be performed by a wireless communication device, in some embodiments. Additional, fewer, or different operations may be performed in the method 800 depending on the embodiment. At least one aspect of the operations is directed to a system, method, apparatus, or a computer-readable medium.

A wireless communication device (e.g., a UE) may send an indication of capability of the wireless communication device to a wireless communication node (e.g., a BS). The capability can be associated with pre-compensation of segments of an uplink transmission. The wireless communication device may transmit the uplink transmission (e.g., repetitions of physical uplink shared channel (PUSCH) transmissions) with a time domain window (TDW) for bundling of demodulation reference signals (DMRSes) according to the capability. In some embodiments, the actual TDW can be determined by the UE when events (which violate power consistency and phase continuity) occur. The UE may determine the actual TDWs. Events, which cause power consistency and phase continuity not to be maintained across PUSCH transmissions of PUSCH repetition type A scheduled by DCI format 0_1 or 0_2, or PUSCH repetition Type A with a configured grant, or PUSCH repetition type B or TB processing over multiple slots, or PUCCH transmissions of PUCCH repetition, within the nominal TDW, can be uplink timing adjustment or frequency hopping.

In some embodiments, the capability may comprise at least one of: (1) capability of the wireless communication device to perform the pre-compensation of the segments of the uplink transmission; (2) capability of the wireless communication device to support or provide a segment length for the pre-compensation of the segments; (3) capability of the wireless communication device to support a TDW size that is longer than the segment length for the pre-compensation of the segments; or (4) capability of the wireless communication device to support a maximum TDW size that is longer than the segment length for the pre-compensation of the segments.

In some embodiments, the wireless communication device may determine the TDW for bundling of DMRSes, according to at least one of: a new event of the pre-compensation of segments that violates power consistency and phase continuity between the segments; assistance information of the wireless communication device that is indicative of updated information or timing information of the pre-compensation; or a configuration of the wireless communication node that is indicative of the updated information or timing information of the pre-compensation. The TDW can be determined by assistance information and can define a new event of segmented pre-compensation. The assistance information can include reported assistance information by the UE or configuration indicated by the network

In some embodiments, the wireless communication device may receive, from the wireless communication node, an indication of whether the wireless communication node is to perform phase post-compensation. The wireless communication device may receive, from the wireless communication node, a configuration information comprising at least one of a nominal TDW, a segment length for the pre-compensation of the segments, or a maximum TDW size across multiple segments. The wireless communication device may send, to the wireless communication node, assistance information comprising at least one of an indication of the segment length or timing information of the pre-compensation of the segments. The timing information may include at least one of: a start time or an end time, of the pre-compensation or the TDW. The UE can send a signal to the BS when the UE starts/ends the pre-compensation. The UE can calculate/estimate/send the start/end time of the pre-compensation. The timing information can be a time instance, or a system frame number (SFN). When the capability comprises (1) or (2), the method may comprise: determining the actual TDW that is to end before the new event occurs, according to at least one of: the segment length, the start time, or the end time (e.g., last symbol of a PUSCH transmission before the event).

When the capability comprises (3) or (4), the method comprises: determining the actual TDW according to at least one of: a scaling factor, or an offset with respect to a the segment length configured by the wireless communication node, or a nominal TDW indicated by the wireless communication node; or a maximum TDW indicated by the wireless communication device. A new TDW can be configured by the network, e.g., segment length or longer than segment length. The nominal TDW can be determined by the UE from BS the indication (e.g., PUSCH−TimeDomainWindowLength) if configured. The nominal TDW can be computed as min ([maxDMRS−BundlingDuration], M), if PUSCH-TimeDomainWindowLength is not configured. [maxDMRS−BundlingDuration] can be a maximum duration for a nominal TDW subject to UE capability. M can be the time duration in consecutive slots for all PUSCH repetitions transmissions. A maximum TDW can be subject to UE capability of across segments.

In some embodiments, the method may comprise: determining the TDW to have at least one of: a start time occurring at a first symbol of a first physical uplink shared channel (PUSCH) transmission in a slot, from PUSCH transmissions of the uplink transmission over multiple slots within a nominal TDW, or an end time occurring at a last symbol of a last PUSCH transmission in the another slot, from the PUSCH transmissions within the nominal TDW. The start and end times may not be in the same slot, but can be in same nominal TDW. The PUSCH transmission may include multiple repetitions.

When the capability comprises (1) or (2), and the wireless communication node is to perform post-compensation of phase drift, the method may comprise: determining the TDW according to at least one of: a scaling factor, or an offset with respect to a segment length configured by the wireless communication node, a nominal TDW indicated by the wireless communication node; or a maximum TDW indicated by the wireless communication device.

When the capability comprises (1) or (2), and the wireless communication node is to perform post-compensation of phase drift, the method may comprise: determining the TDW to have at least one of: a start time occurring at a first symbol of a first physical uplink shared channel (PUSCH) transmission in a slot, from PUSCH transmissions of the uplink transmission over multiple slots within a nominal TDW, or an end time occurring at a last symbol of a last PUSCH transmission in the slot, from the PUSCH transmissions within the nominal TDW. When the capability comprises (1) or (2), and the wireless communication node is not to perform post-compensation of phase drift, the method may comprise: determining the TDW according to at least one of: the segment length, the start time, or the end time.

In some embodiments, the wireless communication device may send, to the wireless communication node, via at least one signaling, at least one of: the indication of the capability, or the assistance information. The at least one signaling may comprise at least one of: a radio access control (RRC) signaling; or a medium access control control element (MAC CE) signaling. The wireless communication device may receive the indication of whether the wireless communication node is to perform post-compensation of phase drift and new event of segmented pre-compensation, to the wireless communication node via at least one of: a radio access control (RRC) signaling; a master information block (MIB) signaling; or a system information block (SIB) signaling.

In some embodiments, when (i) the wireless communication node configures a nominal TDW that is longer than a segment length for the pre-compensation of the segments, and (ii) the capability comprises (1) or (2), the method may comprise: determining the TDW according to at least one of: the segment length, the start time, or the end time. When the wireless communication node configures a nominal TDW that is equal to a segment length for the pre-compensation of the segments, the method may comprise: determining the TDW according to the nominal TDW configured by the wireless communication device. When the wireless communication node configures a nominal TDW that is equal to maximum TDW size that is longer than a segment length for the pre-compensation of the segments, the method may comprise: determining the TDW according to the maximum TDW.

In some embodiments, when the capability comprises that the wireless communication device cannot perform the pre-compensation, the TDW can be determined via a defined or pre-existing approach.

In some embodiments, a wireless communication node (e.g., a BS) may receive an indication of capability of the wireless communication device from a wireless communication device (e.g., a UE). The capability can be associated with pre-compensation of segments of an uplink transmission (e.g., repetitions of PUSCH transmissions). The wireless communication node may receive, from the wireless communication device, the uplink transmission with a time domain window (TDW) for bundling of demodulation reference signals (DMRSes), according to the capability.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
transmitting, by a wireless communication device to a wireless communication node, an indication of capability of the wireless communication device, the capability associated with pre-compensation of segments of an uplink transmission; and
transmitting, by the wireless communication device to the wireless communication node, the uplink transmission with a time domain window (TDW) for bundling of demodulation reference signals (DMRSes), according to the capability.

2. The method of claim 1, wherein the capability comprises at least one of:
(1) capability of the wireless communication device to perform the pre-compensation of the segments of the uplink transmission;
(2) capability of the wireless communication device to support or provide a segment length for the pre-compensation of the segments;
(3) capability of the wireless communication device to support a TDW size that is longer than the segment length for the pre-compensation of the segments; or
(4) capability of the wireless communication device to support a maximum TDW size that is longer than the segment length for the pre-compensation of the segments.

3. The method of claim 1, further comprising determining, by wireless communication device, the TDW for bundling of DMRSes, according to at least one of:
a new event of the pre-compensation of segments that violates power consistency and phase continuity between the segments;
assistance information of the wireless communication device that is indicative of updated information or timing information of the pre-compensation; or
a configuration of the wireless communication node that is indicative of the updated information or timing information of the pre-compensation.

4. The method of claim 3, further comprising:
receiving, by the wireless communication device from the wireless communication node, an indication of whether the wireless communication node is to perform phase post-compensation; or
receiving, by the wireless communication device from the wireless communication node, a configuration comprising at least one of a nominal TDW, a segment length for the pre-compensation of the segments, or a maximum TDW size across multiple segments; or sending, by the wireless communication device to the wireless communication node, assistance information comprising at least one of an indication of the segment length or timing information of the pre-compensation of the segments.

5. The method of claim 4, wherein the timing information includes at least one of: a start time or an end time, of the pre-compensation or the TDW.

6. The method of claim 4, wherein when the capability comprises (1) or (2), the method comprises:
determining the TDW that is to end before the new event occurs, according to at least one of: the segment length, the start time, or the end time.

7. The method of claim 4, wherein when the capability comprises (3) or (4), the method comprises:
determining the TDW according to at least one of:
a scaling factor, or an offset with respect to the segment length configured by the wireless communication node, or
a nominal TDW indicated by the wireless communication node; or
a maximum TDW indicated by the wireless communication device.

8. The method of claim 7, comprising:
determining the TDW to have at least one of:
a start time occurring at a first symbol of a first physical uplink shared channel (PUSCH) transmission in a slot, from PUSCH transmissions of the uplink transmission over multiple slots within a nominal TDW, or
an end time occurring at a last symbol of a last PUSCH transmission in another slot, from the PUSCH transmissions within the nominal TDW.

9. The method of claim 4, wherein when the capability comprises (1) or (2), and the wireless communication node is to perform post-compensation of phase drift, the method comprises:
determining the TDW according to at least one of:
a scaling factor, or an offset with respect to a segment length configured by the wireless communication node,
a nominal TDW indicated by the wireless communication node; or
a maximum TDW indicated by the wireless communication device.

10. The method of claim 4, wherein when the capability comprises (1) or (2), and the wireless communication node is to perform post-compensation of phase drift, the method comprises:
determining the TDW to have at least one of:
a start time occurring at a first symbol of a first physical uplink shared channel (PUSCH) transmission in a slot, from PUSCH transmissions of the uplink transmission over multiple slots within a nominal TDW, or
an end time occurring at a last symbol of a last PUSCH transmission in the slot, from the PUSCH transmissions within the nominal TDW.

11. The method of claim 5, wherein when the capability comprises (1) or (2), and the wireless communication node is not to perform post-compensation of phase drift, the method comprises:
determining the TDW according to at least one of: the segment length, the start time, or the end time.

12. The method of claim 4, comprising:
sending, by the wireless communication device to the wireless communication node, via at least one signaling, at least one of: the indication of the capability, or the assistance information,
wherein the at least one signaling comprises at least one of:
a radio access control (RRC) signaling; or
a medium access control control element (MAC CE) signaling.

13. The method of claim 4, comprising:
receiving, by the wireless communication device, the indication of whether the wireless communication node is to perform post-compensation of phase drift and new event of segmented pre-compensation, to the wireless communication node via at least one of:
a radio access control (RRC) signaling;
a master information block (MIB) signaling; or
a system information block (SIB) signaling.

14. The method of claim 5, wherein when (i) the wireless communication node configures a nominal TDW that is longer than a segment length for the pre-compensation of the segments, and (ii) the capability comprises (1) or (2), the method comprises:
determining the TDW according to at least one of: the segment length, the start time, or the end time.

15. The method of claim 5, wherein when the wireless communication node configures a nominal TDW that is equal to a segment length for the pre-compensation of the segments, the method comprises:
determining the TDW according to the nominal TDW configured by the wireless communication device.

16. The method of claim 5, wherein when the wireless communication node configures a nominal TDW that is equal to maximum TDW size that is longer than a segment length for the pre-compensation of the segments, the method comprises:
determining the TDW according to the maximum TDW.

17. The method of claim 1, wherein when the capability comprises that the wireless communication device cannot perform the pre-compensation, the TDW is determined via a defined or pre-existing approach.

18. A method comprising:
receiving, by a wireless communication node from a wireless communication device, an indication of capability of the wireless communication device, the capability associated with pre-compensation of segments of an uplink transmission,
receiving, by the wireless communication node from the wireless communication device, the uplink transmission with a time domain window (TDW) for bundling of demodulation reference signals (DMRSes), according to the capability.

19. A wireless communication device, comprising:
at least one processor configured to:
transmit, via a transceiver to a wireless communication node, an indication of capability of the wireless communication device, the capability associated with pre-compensation of segments of an uplink transmission; and
transmit, via the transceiver, the uplink transmission with a time domain window (TDW) for bundling of demodulation reference signals (DMRSes), according to the capability.

20. A wireless communication node, comprising:
at least one processor configured to:
receive, via a transceiver from a wireless communication device, an indication of capability of the wireless communication device, the capability associated with pre-compensation of segments of an uplink transmission,
receive, via the transceiver from the wireless communication device, the uplink transmission with a time domain window (TDW) for bundling of demodulation reference signals (DMRSes), according to the capability.
